(19) United States
(12) Patent Application Publication
(10) Pub. No.: US 2026/0040376 A1
(43) Pub. Date: Feb. 5, 2026

(54) TERMINAL CONTROL METHOD

(71) Applicant: PANASONIC AUTOMOTIVE SYSTEMS CO., LTD., Kanagawa (JP)

(72) Inventors: Tsuyoshi NISHIO, Chiba (JP); Toshihiro MIYAMICHI, Kanagawa (JP)

(73) Assignee: PANASONIC AUTOMOTIVE SYSTEMS CO., LTD., Kanagawa (JP)

(21) Appl. No.: 19/281,931

(22) Filed: Jul. 28, 2025

(30) Foreign Application Priority Data
Aug. 2, 2024 (JP) 2024-127841

(51) Int. Cl. H04W 76/14; H04L 9/40; H04W 4/024; H04W 76/12

(52) U.S. Cl. CPC H04W 76/14; H04L 63/08; H04W 4/024; H04W 76/12

(57) ABSTRACT

A terminal control method executed by a terminal including a wireless communication device, a display device, and a vibration device includes transmitting, by the wireless communication device, a call request for a vehicle to an outside; receiving first information associated with the call request from the outside in the wireless communication device; displaying, by the display device, a first display corresponding to the first information; displaying, by the display device, a second display different from the first display when the wireless communication device receives a notification that the first display displayed on the display device is recognized by the vehicle from the outside; and vibrating the vibration device when the wireless communication device receives a notification that the second display displayed on the display device is recognized by the vehicle from the outside.

### TECHNICAL FIELD

The present disclosure relates to a terminal control method.

### BACKGROUND ART

When there are a plurality of other persons near the person who called a taxi, it is difficult for the called taxi to recognize which person is the person who called the taxi. On the other hand, Patent Literature 1 discloses that, when a passenger makes a vehicle dispatch request to a center server from his/her mobile phone terminal by using a network access function, the center server sequentially checks whether the vehicle dispatch is possible to a crew terminal of a taxi that is a vehicle dispatch candidate, and when receiving a vehicle dispatch acceptance from any crew terminal, the center server distributes map information covering from positions of both terminals to a desired vehicle dispatch point to the both of them, and thereafter, a line path of a call line or a data communication line between the mobile phone terminal of the passenger and the crew terminal is set to enable terminal-to-terminal communication, and further, when a terminal-to-terminal distance becomes close, a display on the passenger side is brought into a specific light emission blinking state, allowing a driver of a taxi to visually confirm that the passenger is the one who made a reservation.

### CITATION LIST

### Patent Literature

Patent Literature 1: JP2012-88925A
Patent Literature 2: JP2005-250554A
Patent Literature 3: JP2017-224343A

### SUMMARY OF INVENTION

However, setting the display on the passenger side to the specific light emission blinking state as disclosed in Patent Literature 1 is intended for the driver of the taxi to visually check, and thus there is room for improvement, for example, in a case where the display is automatically read by a camera or the like included in the taxi. In addition, a user of the terminal cannot check the terminal and cannot grasp a status of the taxi while the terminal in the light emission blinking state is directed toward the taxi.

An object of the present disclosure is to provide a technique that enables a taxi to recognize a terminal that has called the taxi and enables a user of the terminal to grasp a situation of the taxi.

The present disclosure provides a terminal control method executed by a terminal including a wireless communication device, a display device, and a vibration device. The terminal control method includes transmitting, by the wireless communication device, a call request for a vehicle to an outside; receiving first information associated with the call request from the outside in the wireless communication device; displaying, by the display device, a first display corresponding to the first information; displaying, by the display device, a second display different from the first display when the wireless communication device receives a notification that the first display displayed on the display device is recognized by the vehicle from the outside; and vibrating the vibration device when the wireless communication device receives a notification that the second display displayed on the display device is recognized by the vehicle from the outside.

These comprehensive or specific aspects may be implemented by a system, a device, a method, an integrated circuit, a computer program, or a recording medium, or any combination of the system, the device, the method, the integrated circuit, the computer program, and the recording medium.

According to the present disclosure, the terminal that has called a taxi can be recognized by the taxi, and a user of the terminal can grasp a situation of the taxi.

### BRIEF DESCRIPTION OF DRAWINGS

FIG. 1 is a schematic diagram illustrating an outline of an operation of a vehicle dispatch system according to Embodiment 1;

FIG. 2 is a block diagram illustrating a configuration example of the vehicle dispatch system according to Embodiment 1;

FIG. 3 is a sequence diagram illustrating an operation example of the vehicle dispatch system according to Embodiment 1;

FIGS. 4A to 4D are diagrams illustrating an example in which a first image and a second image according to Embodiment 1 include a two-dimensional code;

FIGS. 5A to 5C are diagrams illustrating an example in which the first image according to Embodiment 1 includes a color change pattern;

FIGS. 6A to 6C are diagrams illustrating an example of changing a type of color in the color change pattern according to Embodiment 1 in accordance with the environment;

FIGS. 7A to 7D are diagrams illustrating an example in which the first image according to Embodiment 1 includes a color change pattern and the second image includes a multi-color change pattern;

FIG. 8 is a flowchart illustrating processing performed by a user terminal according to Embodiment 1;

FIG. 9 is a flowchart illustrating processing performed by a taxi according to Embodiment 1; and

FIG. 10 is a flowchart illustrating processing performed by a server device according to Embodiment 1.

### DESCRIPTION OF EMBODIMENTS

Hereinafter, an embodiment of the present disclosure will be described in detail with reference to the drawings as appropriate. However, unnecessarily detailed description may be omitted. For example, detailed description of already well-known matters and redundant description of substantially the same configuration may be omitted. This is to avoid unnecessary redundancy of the following description and to facilitate understanding of those skilled in the art. The accompanying drawings and the following description are provided for those skilled in the art to sufficiently understand the present disclosure, which are not intended to limit the subject matter described in the claims. Functions of one configuration illustrated in the present embodiment may be implemented by two or more physical configurations, or functions of two or more configurations may be implemented by, for example, one physical configuration.

### Embodiment 1

### Outline

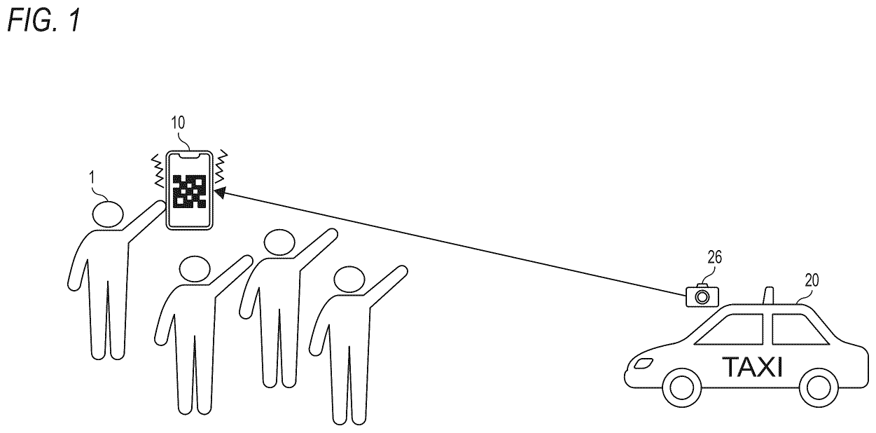

FIG. 1 is a schematic diagram illustrating an outline of an operation of a vehicle dispatch system according to Embodiment 1.

In Embodiment 1, as illustrated in FIG. 1, a user 1 who has made a call request for a taxi 20 holds up the user terminal 10 on which a predetermined image is displayed. The taxi 20 recognizes the user 1 who has made the call request for the taxi 20 by automatically identifying information included in the image displayed on the user terminal 10 by a vehicle exterior camera 26 included in the taxi 20. The taxi 20 may have an autonomous driving function. However, the taxi 20 may be manually driven by a driver.

As a result, as illustrated in FIG. 1, even when there are a plurality of other persons waiting for another taxi near the user 1 who has made the call request for the taxi 20, the taxi 20 can recognize the user 1 who has made the call request for the taxi 20.

This will be described in detail below. The taxi 20 in Embodiment 1 may be simply read as a vehicle. The user 1 may be read as a passenger or a person.

### <System Configuration>

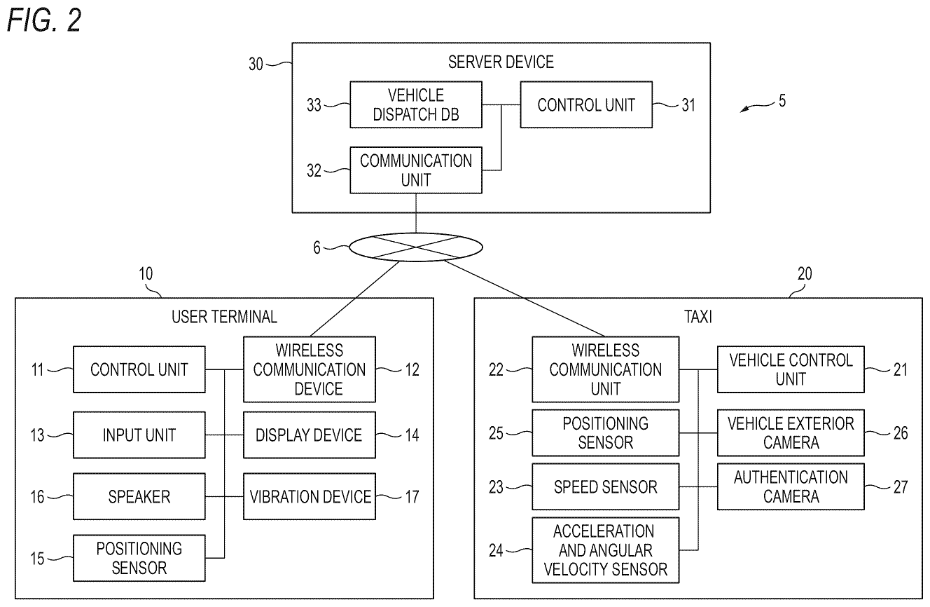

FIG. 2 is a block diagram illustrating a configuration example of a vehicle dispatch system 5 according to Embodiment 1.

The vehicle dispatch system 5 includes the user terminal 10, the taxi 20, and a server device 30. The user terminal 10, the taxi 20, and the server device 30 can transmit and receive information to and from each other through a communication network 6. Examples of the communication network 6 include a wired LAN, a wireless LAN, the Internet, a mobile communication network, and the like.

### <User Terminal>

The user terminal 10 includes a control unit 11, a wireless communication device 12, an input unit 13, a display device 14, a positioning sensor 15, a speaker 16, and a vibration device 17. Examples of the user terminal 10 include a smartphone, a tablet terminal, a smart watch, and the like.

The control unit 11 includes, for example, a storage unit (not illustrated) that stores a program and data, and implements the functions of the user terminal 10 according to Embodiment 1 by reading and executing the program and the data from the storage unit. The functions of the user terminal 10 will be described as appropriate. Further, the processing described with the user terminal 10 or the control unit 11 as a main body in Embodiment 1 may be processing realized by the control unit 11 executing predetermined software or application installed in the user terminal 10. The control unit 11 may be read as a processor, a central processing unit (CPU), a graphics processing unit (GPU), or a neural processing unit (NPU).

The wireless communication device 12 is connected to the communication network 6 and controls, for example, transmission and reception of information to and from the server device 30.

The input unit 13 is a device that receives an input from a user. Examples of the input unit 13 include a touch panel, a button, a switch, a microphone, and the like.

The display device 14 is a device that displays information and an image. Examples of the display device 14 include a liquid crystal display, an organic EL display, and the like. As represented by a touch panel display, the input unit 13 and the display device 14 may be an integrated device.

The positioning sensor 15 is a sensor for measuring a current position of the user terminal 10. For example, the positioning sensor 15 receives signals of global navigation satellite systems (GNSS) and measures the current position of the user terminal 10.

The speaker 16 outputs sound in response to an instruction from the control unit 11.

The vibration device 17 generates a vibration in response to an instruction from the control unit 11. The vibration device 17 may be read as a vibrator. The vibration device 17 may include a speaker.

### Taxi

The taxi 20 includes a vehicle control unit 21, a wireless communication unit 22, a speed sensor 23, an acceleration and angular velocity sensor 24, a positioning sensor 25, the vehicle exterior camera 26, and an authentication camera 27. These components can transmit and receive information to and from each other through an in-vehicle network 28. Examples of the in-vehicle network 28 include controller area network (CAN), LIN, FlexRay, in-vehicle Ethernet, media oriented systems transport (MOST), and the like. The in-vehicle network 28 may be a wired network or a wireless network.

The vehicle control unit 21 performs a control for realizing the functions of the taxi 20 according to Embodiment 1. The functions of the taxi 20 will be described as appropriate. The vehicle control unit 21 may be read as, an electronic control unit (ECU), a processor, a controller, or the like.

The wireless communication unit 22 is connected to the communication network 6 and controls, for example, transmission and reception of information to and from the server device 30.

The speed sensor 23 is a sensor for measuring a speed of the taxi during traveling.

The acceleration and angular velocity sensor 24 is a sensor for measuring an acceleration and an angular velocity when the taxi 20 is traveling.

The positioning sensor 25 is a sensor for measuring the current position of the taxi 20. For example, the positioning sensor 25 receives the GNSS signal and measures the current position of the taxi 20. The positioning sensor 25 may measure the current position with higher accuracy at the position measured using the GNSS signal in consideration of the speed measured by the speed sensor 23 and the acceleration and the angular velocity measured by the acceleration and angular velocity sensor 24.

The vehicle exterior camera 26 is a camera capable of capturing an image of the outside of the taxi 20.

The authentication camera 27 is a camera for authenticating the user 1 getting into the taxi 20.

### Server Device

The server device 30 includes a control unit 31, a communication unit 32, and a vehicle dispatch database (DB) 33.

The control unit 31 includes, for example, a storage unit (not illustrated) that stores a program and data, and implements the functions of the server device 30 according to Embodiment 1 by reading and executing the program and the data from the storage unit. The functions of the server device 30 will be described as appropriate. The control unit 31 may be read as a processor, a CPU, a GPU, or an NPU.

The communication unit 32 is connected to the communication network 6 and controls transmission and reception of information to and from, for example, the user terminal 10 or the taxi 20.

The vehicle dispatch DB 33 is a DB for managing dispatch of the taxi 20 to the user 1. For example, the vehicle dispatch DB 33 manages the current position of each taxi 20. For example, the vehicle dispatch DB 33 manages a call request for the taxi 20 from the user terminal 10 and the taxi 20 assigned (that is, dispatched) to the call request.

### Operation of Vehicle Dispatch System

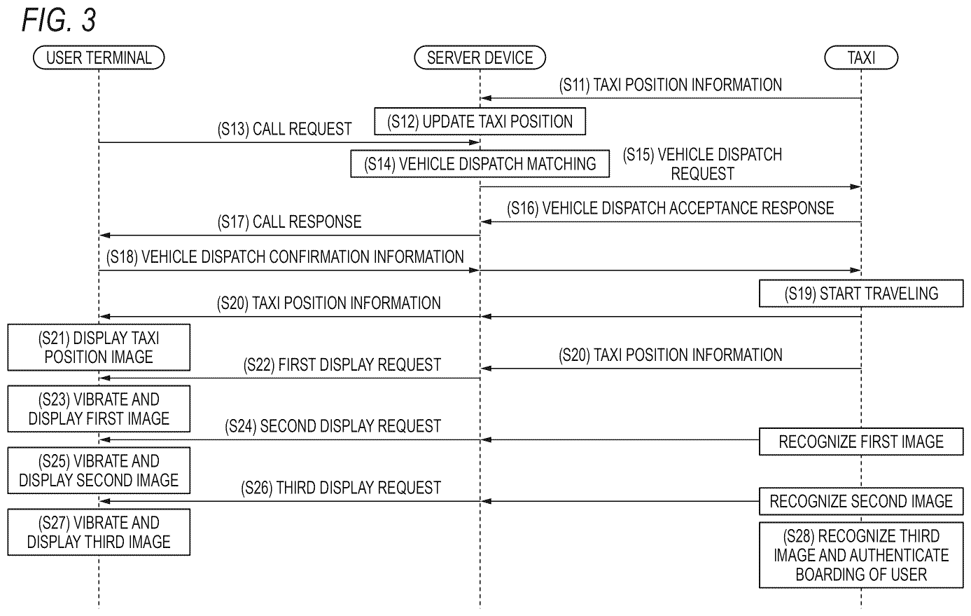

FIG. 3 is a sequence diagram illustrating an operation example of the vehicle dispatch system 5 according to Embodiment 1. Next, an outline of the operation of the vehicle dispatch system 5 will be described with reference to FIG. 3.

The taxi 20 periodically transmits taxi position information indicating the position of the taxi 20 to the server device 30 (S11).

The server device 30 updates the taxi position information managed by the vehicle dispatch DB 33 based on the received taxi position information (S12). Accordingly, the server device 30 can grasp the current position of each taxi.

When the user 1 operates the user terminal 10 to make the call request for the taxi 20, the user terminal 10 transmits the call request to the server device 30 together with a user position information indicating a position of the user terminal 10 (S13).

The server device 30 receives the call request from the user terminal 10, refers to the vehicle dispatch DB 33, and starts vehicle dispatch matching (S14).

The server device 30 detects a taxi 20 present near a position indicated by the user position information (for example, within a predetermined range) by the vehicle dispatch matching, and transmits a vehicle dispatch request to the detected taxi 20 together with the user position information (S15). The taxi 20 receives the vehicle dispatch request.

When accepting the received vehicle dispatch request, the taxi 20 transmits a vehicle dispatch acceptance response to the server device 30 together with the taxi position information of the taxi 20 (S16).

The server device 30 receives the vehicle dispatch acceptance response, determines to dispatch the taxi 20 that has made the vehicle dispatch acceptance response to the position of the user terminal 10 that has made the call request, and ends the vehicle dispatch matching. At this time, in the vehicle dispatch DB 33, the server device 30 manages the user who has made the call request and the taxi 20 determined to be dispatched in association with each other. Then, the server device 230 transmits a call response to the user terminal 10 together with the taxi position information of the taxi 20 determined to be dispatched (S17).

When the user terminal 10 receives the call response from the server device 30 and confirms the vehicle dispatch, the user terminal 10 transmits vehicle dispatch confirmation information to the taxi 20 via the server device 30 (S18). The vehicle dispatch confirmation information may be directly transmitted to the taxi 20 without passing through the server device 30.

The taxi 20 receives the vehicle dispatch confirmation information and starts traveling toward the position indicated by the user position information (S19).

The taxi 20 periodically transmits the taxi position information to the user terminal 10 via the server device 30 (S20). The taxi position information may be directly transmitted to the user terminal 10 without passing through the server device 30.

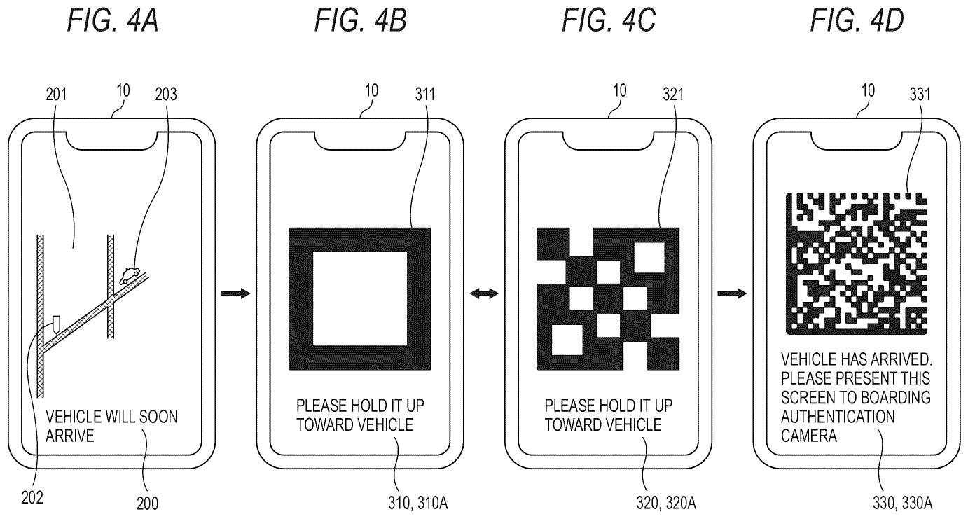

The user terminal 10 displays a taxi position image 200 in which the position indicated by the taxi position information (that is, the current position of the taxi) is superimposed on the map on the display device 14 (S21). An example of the taxi position image 200 will be described later (see FIGS. 4, 5, and 7). Thus, the user 1 can check the current position of the taxi responding to the call request from the user terminal 10.

When a distance between the position indicated by the taxi position information and the position indicated by the user position information is less than a predetermined first threshold value, the server device 30 notifies the user terminal 10 of a first display request (S22). The taxi 20 may directly notify the user terminal 10 of the first display request.

When the notification of the first display request is received, the user terminal 10 vibrates the vibration device 17 (or outputs sound from the speaker 16) and displays a first image 310 on the display device 14 (S23). Examples of the first image 310 will be described later (see FIGS. 4A to 4D, 5, 6, and 7).

When the taxi 20 approaches the user terminal 10 and recognizes the first image 310 displayed on the user terminal 10 by the vehicle exterior camera 26, the taxi 20 notifies the user terminal 10 of a second display request via the server device 30 (S24). The taxi 20 may directly notify the user terminal 10 of the second display request.

When the second display request is received, the user terminal 10 vibrates the vibration device 17 (or outputs sound from the speaker 16) and displays a second image 320 on the display device 14 (S25). Examples of the second image 320 will be described later (see FIGS. 4A to 4D, 5, 6, and 7).

When the taxi 20 further approaches the user terminal 10 and recognizes the second image 320 displayed on the user terminal 10 by the vehicle exterior camera 26, the taxi 20 notifies the user terminal 10 of a third display request via the server device 30 (S26). The taxi 20 may directly notify the user terminal 10 of the third display request.

When the third display request is received, the user terminal 10 vibrates the vibration device 17 (or outputs sound from the speaker 16) and displays a third image 330 on the display device 14 (S27). An example of the third image 330 will be described later (see FIGS. 4, 5, and 7).

The taxi 20 recognizes the third image 330 displayed on the user terminal 10 with the authentication camera 27, and performs boarding authentication of the user 1 (S28). When the boarding authentication of the user 1 is successful, the taxi 20 allows the user 1 to get into and moves to a destination designated by the user 1.

Next, the taxi position image 200, the first image 310, the second image 320, and the third image 330 will be described in detail.

### When First Image and Second Image Include Two-Dimensional Code

FIGS. 4A to 4D are diagrams illustrating an example in which the first image 310 and the second image 320 according to Embodiment 1 include a two-dimensional code.

In step S21 of FIG. 3, the user terminal 10 displays the taxi position image 200 as illustrated in FIG. 4A on the display device 14. The taxi position image 200 includes a map 201 around the user 1, a current position 202 of the user, and a current position 203 of the taxi. The current position 203 of the taxi in the taxi position image 200 is updated as the taxi 20 moves. Accordingly, the user 1 can check the current position of the taxi 20 by viewing the taxi position image 200 displayed on the user terminal 10.

In step S23 of FIG. 3, when the notification of the first display request is received, the user terminal 10 vibrates the vibration device 17 and displays the first image 310A including a code 311 as illustrated in FIG. 4B on the display device 14. The first image 310A may include a message prompting the user to hold up the screen of the user terminal 10 toward the taxi. Based on the vibration and the message, the user 1 can recognize that the taxi 20 is approaching, and can recognize a timing to hold up the screen of the user terminal 10 toward the taxi 20.

The code 311 of the first image 310A may have a relatively coarse granularity such that the vehicle exterior camera 26 of the taxi 20 can recognize the presence of the code 311 when the user terminal 10 and the taxi 20 are relatively close to each other (for example, at a distance shorter than the first threshold value). That is, the code 311 may have high noise resistance.

The code 311 of the first image 310A may be a two-dimensional code (for example, a QR code (registered trademark)). Alternatively, the code 311 of the first image 310A may be a relatively simple symbol or pattern such as a star or a double circle. The color of the code 311 may be different for each user terminal 10.

Accordingly, the taxi 20 can recognize the presence of the user terminal 10 when the taxi 20 approaches the user terminal 10 to some extent by recognizing the code 311 of the first image 310A with the vehicle exterior camera 26.

In step S25 of FIG. 3, when the notification of the second display request is received, the user terminal 10 vibrates the vibration device 17 and displays the second image 320A including a two-dimensional code 321 as illustrated in FIG. 4C on the display device 14. The second image 320A may include a message prompting the user to hold up the screen of the user terminal 10 toward the taxi. By the vibration, the user 1 can recognize that the taxi 20 is getting closer, even in a state where the user is holding the user terminal 10 toward the taxi 20 in step S23.

The two-dimensional code 321 of the second image 320A may include information that enables the vehicle exterior camera 26 of the taxi 20 to uniquely identify the user terminal 10 that has made the call request. The two-dimensional code 321 indicating information capable of uniquely identifying the user terminal 10 may be generated by the server device 30, included in the second display request, and transmitted to the user terminal 10.

The two-dimensional code 321 of the second image 320A may have finer granularity and a larger amount of information than the code 311 of the first image 310. The taxi 20 can automatically recognize that the user terminal 10 displaying the second image 320A is a source of the call request by recognizing the two-dimensional code 321 of the second image 320A with the vehicle exterior camera 26.

The user terminal 10 may alternately display the first image 310A and the second image 320A when receiving the notification of the first display request. As a result, the taxi 20 can recognize the presence of the user terminal 10 with the vehicle exterior camera 26 and uniquely recognize that the user terminal 10 is the source of the call request.

In step S27 of FIG. 3, when the notification of the third display request is received, the user terminal 10 vibrates the vibration device 17 and displays the third image 330A including a two-dimensional code 331 as illustrated in FIG. 4D on the display device 14. The third image 330A may include a message prompting the user to present the screen of the user terminal to the authentication camera of the taxi. By the vibration, the user 1 can recognize that the taxi 20 corresponding to the call request has arrived even in a state where the user 1 is holding the user terminal 10 toward the taxi 20 in step S25. Then, the user 1 can view the third image 330A displayed on the user terminal 10 and present the two-dimensional code 331 of the third image 330A to the authentication camera 27 of the taxi 20.

The two-dimensional code 331 of the third image 330A may include information for the taxi 20 to authenticate the user 1, acquire information on a destination, and charge. The two-dimensional code 331 may be generated by the server device 30, included in the third display request, and transmitted to the user terminal 10. The two-dimensional code 331 of the third image 330A has finer granularity and a larger amount of information than the two-dimensional code 321 of the second image 320A. The taxi 20 authenticates the user terminal 10 (that is, the user 1) displaying the third image 330A by recognizing the two-dimensional code 331 of the third image 330A with the authentication camera 27, and when the authentication is successful, permits the user 1 to get into the taxi, sets the destination, and starts charging.

Through the above processing, the user terminal 10 displays the first image 310A and the second image 320A as illustrated in FIGS. 4A to 4D, and thus can cause the approaching taxi 20 to recognize the presence of the user terminal 10 and that the user terminal 10 is the source of the call request. Further, by recognizing the first image 310A and the second image 320A, the taxi 20 can recognize the presence of the user terminal 10 that has made the call request and uniquely recognize the user terminal 10 that is the source of call request.

For example, even when the user terminal 10 makes a call request for the taxi 20 from a building group in which the positioning sensor 15 of the user terminal 10 cannot perform positioning with sufficient accuracy, an underground parking lot, an indoor parking lot, or the like, according to the method described above, the taxi 20 can recognize the presence of the user terminal 10 that has made the call request, and can uniquely recognize the user terminal 10 that is the source of the call request.

### When First Image Includes Color Change Pattern

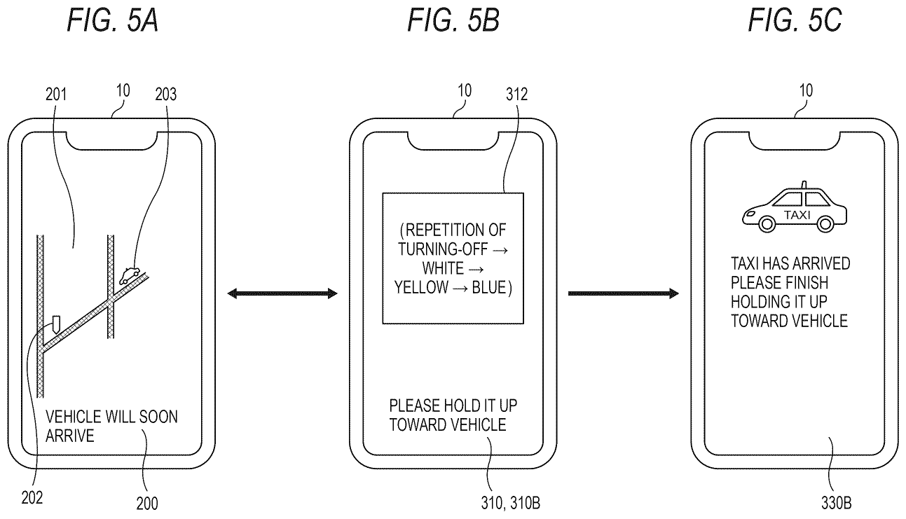

FIGS. 5A to 5C are diagrams illustrating an example in which the first image according to Embodiment 1 includes a color change pattern.

In step S21 of FIG. 3, the user terminal 10 displays the taxi position image 200 as illustrated in FIG. 5A on the display device 14. This is similar to FIG. 4A.

In step S23 of FIG. 3, when the notification of the first display request is received, the user terminal 10 vibrates the vibration device 17 and displays, on the display device 14, a first image 310B including a color area 312 having a predetermined area and whose color changes with time, as illustrated in FIG. 4B. The first image 310B may include a message prompting the user to hold up the screen of the user terminal toward a taxi. By the vibration and the message, the user 1 can recognize that the taxi 20 is approaching, and can recognize the timing to hold up the screen of the user terminal 10 toward the taxi.

The color area 312 of the first image 310B may have a color change pattern in which the vehicle exterior camera 26 of the taxi 20 can uniquely identify the user terminal 10 that is the source of the call request. For example, the color change pattern capable of uniquely identifying the user terminal 10 that has made a certain call request may be repetition of turning-off, white, yellow, and blue. For example, the color change pattern capable of uniquely identifying the user terminal 10 that has made another call request may be repetition of turning-off, red, green, and light blue. Here, the turning-off is set to indicate start of the color change pattern. The color change pattern capable of uniquely identifying the user terminal 10 may be determined by the server device 30, included in the first display request, and transmitted to the user terminal 10.

The number of colors of the color change pattern and a color switching cycle may be changed according to whether the vehicle exterior camera 26 of the taxi 20 is capable of automatically reading the color change pattern. For example, when the vehicle exterior camera 26 of the taxi 20 is capable of automatic reading, the number of colors of the color change pattern and the color switching cycle may be a relatively large number of colors and a relatively short cycle, such as switching between 10 colors at a cycle of 100 ms. For example, when the taxi 20 is not capable of automatic reading and the driver of the taxi 20 visually checks the color change pattern, the number of colors of the color change pattern and the color switching cycle may be a relatively small number of colors and a relatively long cycle, such as switching between three colors at a cycle of 500 ms. However, the number of colors of the color change pattern and the color switching cycle are not limited thereto.

The taxi 20 can uniquely recognize that the user terminal 10 displaying the first image 310B is the source of the call request by recognizing the color change pattern of the color area 312 of the first image 310B with the vehicle exterior camera 26.

Also in step S25 of FIG. 3, the user terminal 10 may perform the same display as in FIG. 5B as the second image. When the approaching taxi 20 does not correspond to the call request after the display in FIG. 5B has been temporarily displayed, the user terminal 10 may return to the display in FIG. 5B.

In step S27 of FIG. 3, when the notification of the third display request is received, the user terminal 10 vibrates the vibration device 17 and displays a third image 330B including a message indicating that a taxi has arrived as illustrated in FIG. 5C on the display device 14. Alternatively, the user terminal 10 may display the third image 330A including the two-dimensional code 331 for authenticating the user 1 as illustrated in FIG. 4D.

Through the above processing, the user terminal 10 can cause the approaching taxi 20 to recognize the presence of the user terminal 10 and uniquely recognize that the user terminal 10 is the source of the call request by displaying the first image 310B (or the second image) as illustrated in FIGS. 5A to 5C. Further, the taxi 20 recognizes the first image 310B (or the second image) with the vehicle exterior camera 26, thereby recognizing the presence of the user terminal 10 that has made the call request and uniquely recognizing the user terminal 10 that has made the source of the call request.

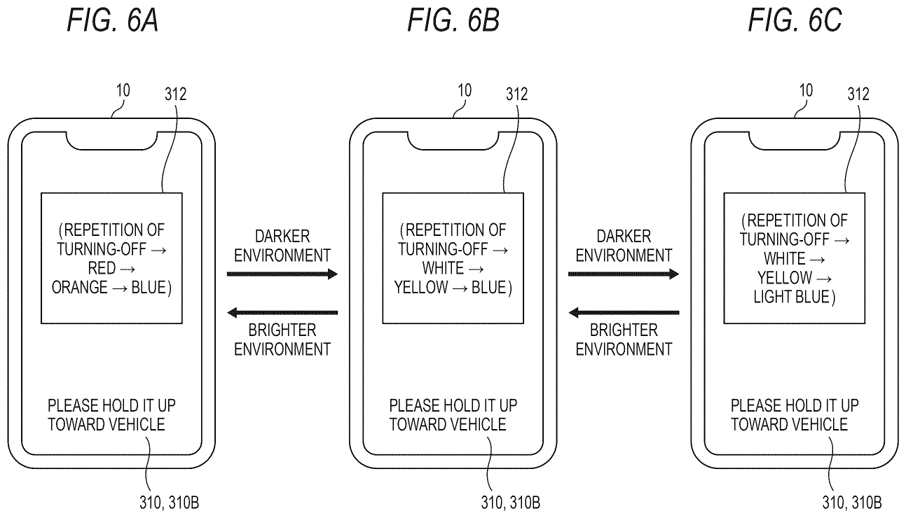

FIGS. 6A to 6C are diagrams illustrating an example of changing a type of color in the color change pattern according to Embodiment 1 according to the environment.

The visibility of color changes depending on the environment around the user terminal 10 (for example, morning, daytime, night, outdoor, indoor, weather, and the like). Therefore, the user terminal 10 and the server device 30 may change the color change pattern so that the type of color is more easily recognized from the vehicle exterior camera 26 of the taxi 20 in the environment around the user terminal 10.

For example, when the environment around the user terminal 10 is a relatively bright environment, such as outdoors where the sun is dazzling, the user terminal 10 and the server device 30 generate a color change pattern using a type of color that stands out in a bright environment such as red, orange color, or blue illustrated in FIG. 6A.

For example, when the environment around the user terminal 10 is an environment with relatively medium brightness, such as cloudy outdoors or slightly bright indoors, the user terminal 10 and the server device 30 generate a color change pattern using a type of color that is easy to see in the environment with medium brightness such as white, yellow, and blue illustrated in FIG. 6B.

For example, when the environment around the user terminal 10 is a relatively dark environment such as nighttime, an underground parking lot, or an indoor parking lot, the user terminal 10 and the server device 30 generate a color change pattern using a type of color that is easy to see in a dark environment such as white, yellow, or light blue illustrated in FIG. 6C.

As a result, it is possible to prevent the vehicle exterior camera 26 of the taxi 20 from reducing the accuracy of recognizing the color change pattern displayed on the user terminal 10, which is the source of the call request, due to a difference in the environment around the user terminal 10.

### <When First Image Includes Color Change Pattern and Second Image Includes Multi-Color Change Pattern>

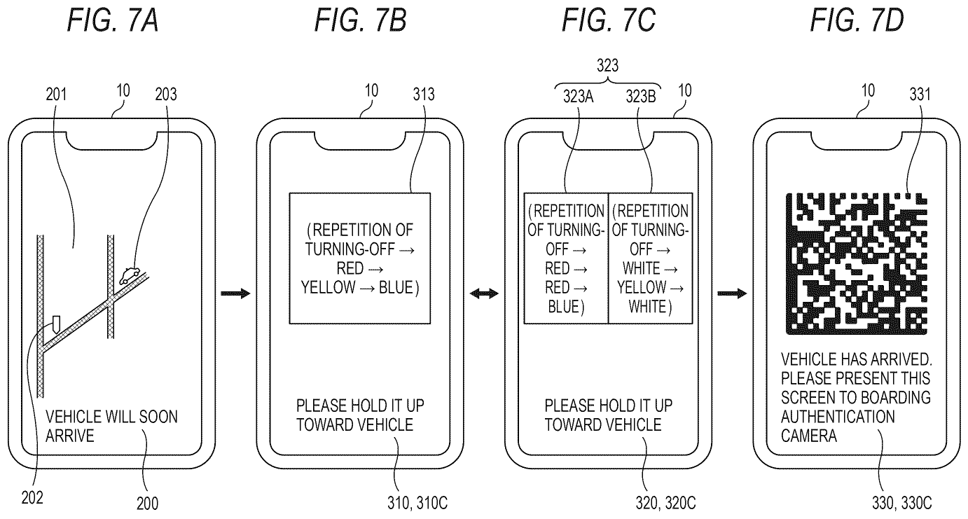

FIGS. 7A to 7D are diagrams illustrating an example in which the first image includes a color change pattern and the second image includes multi-color change pattern according to Embodiment 1.

In step S21 of FIG. 3, the user terminal 10 displays the taxi position image 200 as illustrated in FIG. 7A on the display device 14. This is similar to FIG. 4A.

In step S23 of FIG. 3, when the user terminal 10 receives the notification of the first display request, the user terminal 10 vibrates the vibration device 17 to display, on the display device 14, a first image 310C including a color area 313 having a predetermined area and whose color changes with time, as illustrated in FIG. 7B. The first image 310C may include a message prompting the user to hold up the screen of the user terminal toward a taxi. By the vibration and the message, the user 1 can recognize that the taxi 20 is approaching, and can recognize the timing to hold up the screen of the user terminal 10 toward the taxi.

The color area 313 of the first image 310C may be the same as the color area 312 described in FIG. 5B.

Accordingly, the taxi 20 can recognize the presence of the user terminal 10 when the taxi 20 approaches the user terminal 10 to some extent by recognizing the color change pattern of the color area 312 of the first image 310C with the vehicle exterior camera 26.

When receiving the notification of the first display request, the user terminal 10 may vibrate the vibration device 17 and display the first image 310C including the code 311 as FIG. 4B.

In step S25 of FIG. 3, when the notification of the second display request is received, the user terminal 10 vibrates the vibration device 17 and displays, on the display device 14, a second image 320C including a multi-color area 322 in which the combination of a plurality of colors changes with time as illustrated in FIG. 7C. The second image 320C may include a message prompting the user to hold up the screen of the user terminal toward a taxi. By the vibration, the user 1 can recognize that the taxi corresponding to the call request has arrived even in a state where the user is holding the user terminal 10 toward the taxi 20 in step S25.

The multi-color area 322 of the second image 320C may include a plurality of color areas 323A and 323B each having a predetermined area, and different colors may be displayed in the color areas 323A and 323B. Furthermore, the multi-color area 322 of the second image 320C may have a multi-color change pattern in which the combination of colors changes with time. The multi-color change pattern may be a pattern in which the vehicle exterior camera 26 of the taxi 20 can uniquely identify the user terminal 10 that is the source of the call request. For example, the multi-color change pattern capable of uniquely identifying the user terminal 10 that has made a certain call request may be repetition of a combination of turning-off, red and white, a combination of red and yellow, and a combination of blue and white. For example, the multi-color change pattern capable of uniquely identifying a user terminal that has made another call request may be repetition of a combination of turning-off, green and white, a combination of green and yellow, and a combination of blue and red. Here, the turning-off is set to indicate start of the multi-color change pattern. The multi-color change pattern capable of uniquely identifying the user terminal 10 may be determined by the server device 30, included in the first display request, and transmitted to the user terminal 10.

The multi-color change pattern in the multi-color area 322 of the second image 320C has a larger amount of information than the color change pattern of the color area 313 of the first image 310C.

The taxi 20 can uniquely recognize that the user terminal 10 displaying the second image 320C is the source of the call request by recognizing the multi-color change pattern of the multi-color area 322 of the second image 320C with the vehicle exterior camera 26.

When receiving the notification of the first display request, the user terminal 10 may alternately display the first image 310C and the second image 320C. Accordingly, the taxi 20 can recognize the presence of the user terminal 10 and the fact that the user terminal 10 is the source of the call request by the vehicle exterior camera 26.

In step S27 of FIG. 3, when the notification of the third display request is received, the user terminal 10 vibrates the vibration device 17 and displays the third image 330C including the two-dimensional code 331 as illustrated in FIG. 7D on the display device 14. This is similar to FIG. 4D.

Through the above processing, the user terminal 10 displays the first image 310C and the second image 320C as illustrated in FIGS. 7A to 7D, and thus can cause the approaching taxi 20 to recognize the presence of the user terminal 10 and that the user terminal 10 is the source of the call request. Further, by recognizing the first image 310C and the second image 320C, the taxi 20 can recognize the presence of the user terminal 10 that has made the call request and uniquely recognize the user terminal 10 that is the source of the call request.

### <Processing of User Terminal>

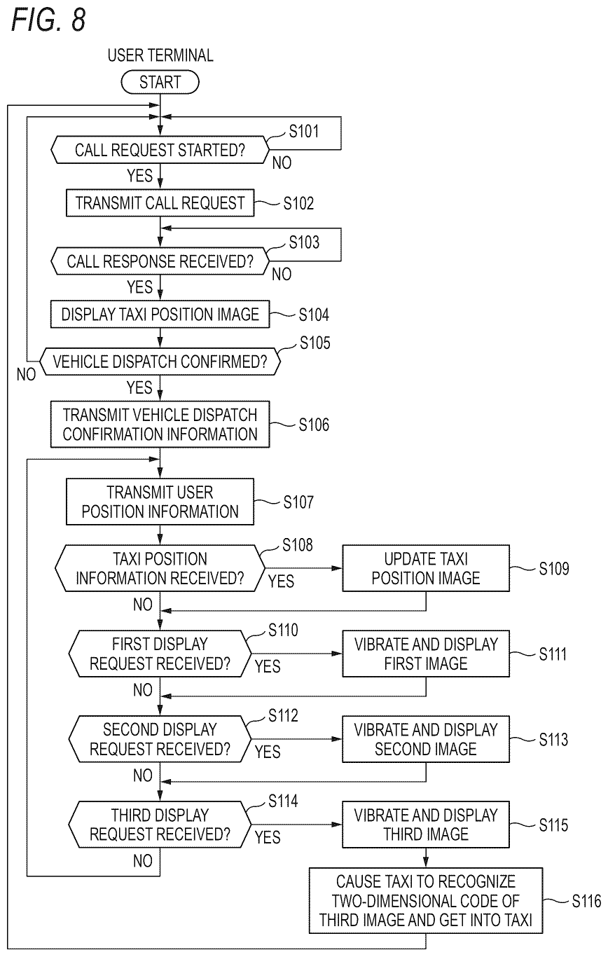

FIG. 8 is a flowchart illustrating processing performed by the user terminal 10 according to Embodiment 1. The processing of the user terminal 10 may be read as processing of the control unit 11 included in the user terminal 10.

The user terminal 10 determines whether the user 1 has started the call request for the taxi 20 (S101). When the user 1 does not start the call request (S101: NO), the user terminal 10 repeats step S101.

When the user 1 starts the call request (S101: YES), the user terminal 10 transmits the call request to the server device 30 (S102).

The user terminal 10 determines whether a call response corresponding to the call request has been received from the server device 30 (S103). When the user terminal 10 has not received the call response yet (S103: NO), the user terminal 10 repeats step S103.

When the call response is received (S103: YES), the user terminal 10 displays the taxi position image 200 on the display device 14 (S104). The user 1 may determine whether to confirm the dispatch of the taxi 20 by viewing the displayed taxi position image 200.

The user terminal 10 determines whether the user 1 has instructed confirmation of vehicle dispatch (S105).

When the user 1 does not instruct the confirmation of the vehicle dispatch (for example, when the vehicle dispatch is canceled) (S105: NO), the user terminal 10 returns the processing to step S101. In this case, the server device 30 may cancel the call request for the taxi 20.

When the user 1 instructs the confirmation of the vehicle dispatch (S105: YES), the user terminal 10 transmits the vehicle dispatch confirmation information to the server device 30 (S106).

The user terminal 10 transmits the user position information (S107).

The user terminal 10 determines whether taxi position information has been received from the server device 30 (S108). When the taxi position information has not been received (S108: NO), the user terminal 10 advances the processing to step S110 as it is.

When the taxi position information is received (S108: YES), the user terminal 10 updates the taxi position image 200 based on the taxi position display (S109), and advances the processing to step S110.

The user terminal 10 determines whether the first display request has been received from the server device 30 (S110). When the first display request has not been received (S110: NO), the user terminal 10 directly advances the processing to step S112.

When the first display request is received (S110: YES), the user terminal 10 vibrates the vibration device 17 and displays the first image 310 (S111), and advances the processing to step S112.

The user terminal 10 determines whether the second display request has been received from the server device 30 (S112). When the second display request has not been received (S112: NO), the user terminal 10 directly advances the processing to step S114.

When the second display request is received (S112: YES), the user terminal 10 vibrates the vibration device 17 and displays the second image 320 (S113), and advances the processing to step S114.

The user terminal 10 determines whether the third display request has been received from the server device 30 (S114). When the third display request has not been received (S114: NO), the user terminal 10 returns the processing to step S107.

When the third display request is received (S114: YES), the user terminal 10 vibrates the vibration device 17 and displays the third image 330 (S115).

The user 1 causes the authentication camera 27 of the taxi 20 to recognize the two-dimensional code 331 of the third image 330 and gets into the taxi 20 (S116). Then, the processing returns to step S101.

Through the above processing, the user terminal 10 displays the first image 310 and the second image 320 as illustrated in FIG. 4, 5, 6, or 7, and thus can cause the approaching taxi 20 to recognize the presence of the user terminal 10 and uniquely recognize that the user terminal 10 is the source of the call request.

### <Processing of Taxi>

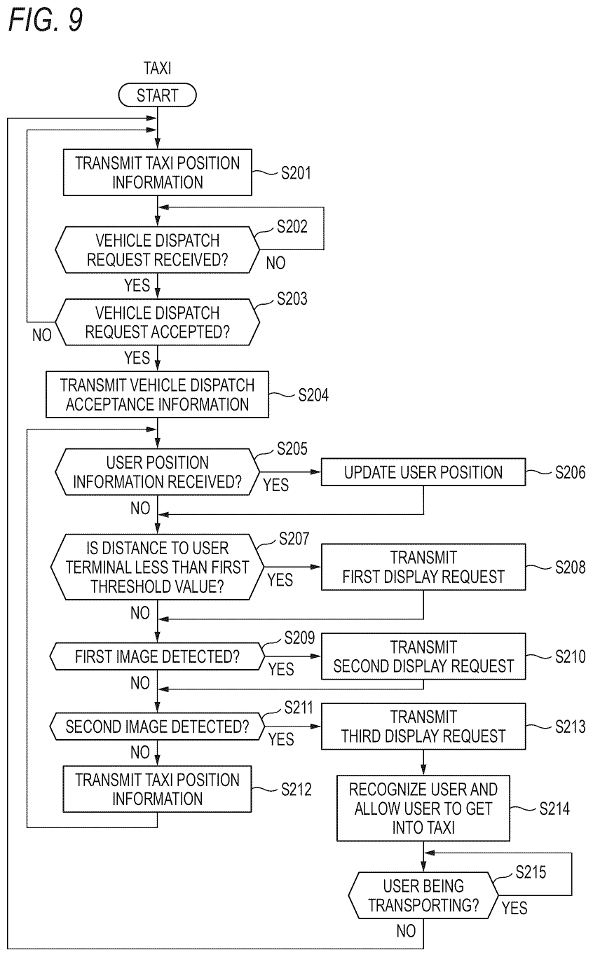

FIG. 9 is a flowchart illustrating processing of the taxi 20 according to Embodiment 1. The processing of the taxi 20 may be read as processing of the vehicle control unit 21 included in the taxi 20.

The taxi 20 periodically transmits the taxi position information to the server device 30 (S201).

The taxi 20 determines whether a vehicle dispatch request has been received from the server device 30 (S202). When the taxi 20 has not received the vehicle dispatch request from the server device 30 (S202: NO), the taxi 20 repeats step S202.

When the vehicle dispatch request is received from the server device 30 (S202: YES), the taxi 20 determines whether the vehicle dispatch request is accepted (S203). When the driver is in the taxi 20, the driver may decide whether to accept the vehicle dispatch request. When the driver is not in the taxi 20 (that is, in a case of fully autonomous driving), the taxi 20 (the vehicle control unit 21) may automatically determine whether to accept the vehicle dispatch request based on various conditions (for example, the remaining fuel or electric energy, a subsequent schedule, or the like).

When the vehicle dispatch request is not accepted (S203: NO), the taxi 20 returns the processing to step S201.

When accepting the vehicle dispatch request (S203: YES), the taxi 20 transmits a vehicle dispatch acceptance response to the server device 30 (S204). Then, the taxi 20 travels toward the position indicated by the user position information.

The taxi 20 determines whether the user position information has been received from the server device 30 (S205). When the user position information has not been received (S205: NO), the taxi 20 advances the processing to step S207.

When the user position information is received (S205: YES), the taxi 20 updates the user position indicated by the user position information (S206), and advances the processing to step S207.

The taxi 20 determines whether a distance between the user position indicated by the user position information and the current position of the taxi (hereinafter referred to as the distance between the taxi and the user) is less than a predetermined first threshold value (S207).

When the distance between the taxi and the user is equal to or greater than the first threshold value (S207: NO), the taxi 20 advances the processing to step S209.

When the distance between the taxi and the user is less than the first threshold value (S207: YES), the taxi 20 transmits the first display request to the user terminal 10 (S208), and advances the processing to step S209.

The taxi 20 determines whether the vehicle exterior camera 26 has detected the first image 310 displayed on the user terminal 10 (S209).

When the vehicle exterior camera 26 does not detect the first image 310 displayed on the user terminal 10 (S209: NO), the taxi 20 advances the processing to step S211.

When the vehicle exterior camera 26 detects the first image 310 displayed on the user terminal 10 (S209: YES), the taxi 20 transmits the second display request to the user terminal 10 (S210), and advances the processing to step S211.

The taxi 20 determines whether the vehicle exterior camera 26 has detected the second image 320 displayed on the user terminal 10 (S211).

When the vehicle exterior camera 26 does not detect the second image 320 displayed on the user terminal 10 (S211: NO), the taxi 20 transmits the taxi position information to the server device 30 and the user terminal 10 (S212), and returns the processing to step S205.

When the vehicle exterior camera 26 detects the second image 320 displayed on the user terminal 10 (S211: YES), the taxi 20 transmits the third display request to the user terminal 10 (S213).

Then, the taxi 20 authenticates the third image 330 displayed on the user terminal 10 with the authentication camera 27, and allows the user 1 to get into the taxi when the authentication is successful (S214).

The taxi 20 repeats step S215 while transporting the user (S215: YES), and returns the processing to step S201 when transportation of the user is completed (S215: NO).

Through the above processing, by recognizing the first image 310 and the second image 320, the taxi 20 can recognize the presence of the user terminal 10 that has made the call request and recognize that the user terminal 10 is uniquely associated with the call request.

The present embodiment is also applicable to a vehicle driven by a driver. For example, when the driver carries a dedicated terminal (for example, a smartphone) and visually recognizes the first image 310 displayed on the user terminal 10 carried by the user, the driver may perform an operation corresponding to YES in step S209 illustrated in FIG. 9 on the dedicated terminal, and the dedicated terminal may perform processing corresponding to step S210 illustrated in FIG. 9. When the driver visually recognizes the second image 320 displayed on the user terminal 10 carried by the user, the driver may perform an operation corresponding to YES in step S211 illustrated in FIG. 9 on the dedicated terminal, and the dedicated terminal may perform processing corresponding to step S213 illustrated in FIG. 9. That is, the processing performed by the taxi 20 in the above description may be executed by the dedicated terminal carried by the driver.

### <Processing of Server Device>

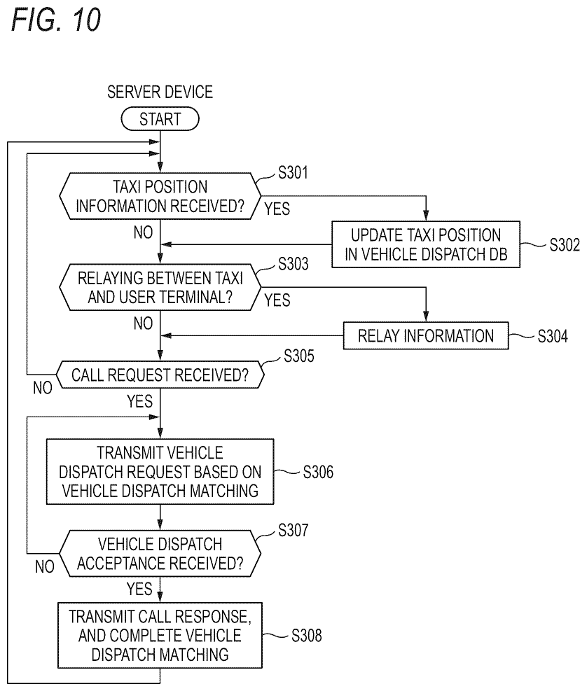

FIG. 10 is a flowchart illustrating processing performed by the server device 30 according to Embodiment 1. The processing of the server device 30 may be read as processing of the control unit 31 included in the server device 30.

The server device 30 determines whether taxi position information has been received from the taxi 20 (S301). When the server device 30 does not receive the taxi position information (S301: NO), the server device 30 directly advances the processing to step S303.

When the server device 30 has received the taxi position information (S301: YES), the server device 30 updates the taxi position information on the vehicle dispatch DB 33 (step S302), and advances the processing to step S303. Accordingly, the server device 30 can grasp the current position of each taxi at the vehicle dispatch DB 33.

The server device 30 determines whether information is being relayed between a certain taxi 20 and a certain user terminal 10 (S303). For example, as in steps S20 to S26 of a sequence chart illustrated in FIG. 3, the relay is being performed while the taxi 20 and the user terminal 10 that have been subjected to the vehicle dispatch matching need to transmit and receive information via the server device 30. When the relay is not being performed (S303: NO), the server device 30 advances the processing to step S305.

When the relay is being performed (S303: YES), the server device 30 relays transmission and reception of information between the taxi 20 and the user terminal 10 (S304), and advances the processing to step S305.

The server device 30 determines whether a call request of the taxi 20 has been received from the user terminal 10 (S305).

When the call request has not been received from the user terminal 10 (S305: NO), the server device 30 returns the processing to step S301.

When the call request has been received from the user terminal 10 (S305: YES), the server device 30 performs the vehicle dispatch matching. For example, the server device 30 refers to the vehicle dispatch DB 33 and transmits the vehicle dispatch request to the taxi 20 near the user terminal 10 (S306).

The server device 30 determines whether a vehicle dispatch acceptance response has been received from the taxi 20 (S307).

When the vehicle dispatch acceptance response has not been received from the taxi 20 (S307: NO), the server device 30 returns the processing to step S306.

When the vehicle dispatch acceptance response has been received from the taxi 20 (S307: YES), the server device 30 transmits the call response to the user terminal 10 and completes the vehicle dispatch matching (S308). Then, the server device 30 returns the processing to step S301.

Through the above processing, the server device 30 can dispatch the taxi 20 to the user who has made the call request for the taxi 20.

### Summary of Embodiment 1

The following techniques are disclosed from the above description of Embodiment 1.

### Technique 1

In a terminal control method executed by a terminal (for example, the user terminal 10) including a wireless communication device (12), a display device (14), and a vibration device (17), the wireless communication device transmits a call request for a vehicle (for example, the taxi 20) to an outside (for example, the server device 30), the wireless communication device receives first information (for example, the first display request) associated with the call request from the outside, the display device displays a first display (for example, the first image 310) corresponding to the first information, the display device displays a second display (for example, the second image 320) different from the first display when the wireless communication unit receives a notification that the first display displayed on the display device is recognized by the vehicle from the outside, and the vibration device vibrates when the wireless communication device receives a notification that the second display displayed on the display device is recognized by the vehicle from the outside.

Accordingly, the vehicle approaching the terminal can recognize the first display and the second display displayed on the terminal and recognize the presence of the terminal. Further, the terminal vibrates when the second display is recognized by the vehicle, so that even in a state where the user of the terminal cannot check the screen of the terminal in order to cause the vehicle to recognize the first display, the terminal can inform the user of a timing at which the second display is recognized by the vehicle.

### Technique 2

In the terminal control method according to Technique 1, the wireless communication device transmits the call request for the vehicle to the outside, the wireless communication device receives the first information associated with the call request from the outside, the display device displays the first display corresponding to the first information, the vibration device vibrates and the display device displays the second display different from the first display when the wireless communication device receives the notification that the first display displayed on the display device is recognized by the vehicle from the outside, and the vibration device vibrates when the wireless communication device receives the notification that the second display displayed on the display device is recognized by the vehicle from the outside.

As described above, the terminal vibrates when the first display is recognized by the vehicle and vibrates when the second display is recognized by the vehicle, with respect to the user of the terminal, so that the user can be informed of the timing at which the first display is recognized by the vehicle and the timing at which the second display is recognized by the vehicle.

### Technique 3

In the terminal control method according to Technique 1 or 2, the wireless communication device transmits the call request for the vehicle to a predetermined server (for example, the server device 30), the wireless communication device receives the first information associated with the call request from the predetermined server, the display device displays the first display, the vibration device vibrates and the display device displays the second display when the wireless communication device receives the notification that the first display displayed on the display device is recognized by the vehicle from the predetermined server, and the vibration device vibrates when the wireless communication device receives the notification that the second display displayed on the display device is recognized by the vehicle from the predetermined server.

As described above, the terminal vibrates when the first display is recognized by the vehicle and vibrates when the second display is recognized by the vehicle, with respect to the user of the terminal, so that the user can be informed of the timing at which the first display is recognized by the vehicle and the timing at which the second display is recognized by the vehicle.

### Technique 4

In the terminal control method according to any one of Techniques 1 to 3, the second display has a larger amount of information than the first display.

Accordingly, in the second display, the vehicle can recognize a larger amount of information.

### Technique 5

In the terminal control method according to any one of Techniques 1 to 4, the first display and the second display each include a two-dimensional code.

Accordingly, the vehicle approaching the terminal can recognize the two-dimensional code displayed on the terminal and recognize the presence of the terminal.

### Technique 6

In the terminal control method according to any one of Techniques 1 to 4, the first display and the second display each are a first color display (for example, the color areas 312 and 313) of a first color, and the first color display has a predetermined area, or the first display and the second display each are a second color display (for example, the multi-color area 322) obtained by combining a plurality of colors, and the second color display has the predetermined area.

Accordingly, the vehicle approaching the terminal can recognize the first color display or the second color display displayed on the terminal and recognize the presence of the terminal.

### Technique 7

In the terminal control method according to any one of Techniques 1 to 4, the first display and the second display each are a third color display of a second color (for example, the color areas 312 and 313), and the third color display has a predetermined area, or the first display and the second display each are switched between a fourth color display of a third color (for example, the color area 323A) and a fifth color display of a fourth color (for example, the color area 323B) one or more times (for example, the multi-color change pattern), and the fourth color display and the fifth color display each have a predetermined area.

Accordingly, the vehicle approaching the terminal can recognize the third color display or the switching between the fourth color display and the fifth color display displayed on the terminal and recognize the presence of the terminal.

### Technique 8

In the terminal control method according to any one of Techniques 1 to 7, the wireless communication device transmits the call request for the vehicle to the outside, the wireless communication device receives the first information associated with the call request from the outside, the display device displays the first display, the display device displays the second display different from the first display when the wireless communication device receives the notification that the first display displayed on the display device is recognized by the vehicle from the outside, and the vibration device vibrates and the display device displays a third display (for example, the third image 330) different from the first display and different from the second display when the wireless communication device receives the notification that the second display displayed on the display device is recognized by the vehicle from the outside.

As described above, the terminal vibrates when the second display is recognized by the vehicle, so that even in a state where the user of the terminal cannot check the screen of the terminal in order to cause the vehicle to recognize the first display, the terminal can inform the user of a timing at which the third display is displayed.

### Technique 9

In the terminal control method according to Technique 8, the third display is used for boarding authentication for the vehicle.

Accordingly, the user of the terminal can perform boarding authentication for the vehicle using the third display displayed on the terminal.

### Technique 10

In the terminal control method according to any one of Techniques 1 to 9, the vibration device includes a vibrator and a speaker.

Accordingly, the terminal can generate a vibration by the vibrator and the speaker.

Although the embodiment has been described above with reference to the accompanying drawings, the present disclosure is not limited thereto. It is apparent to those skilled in the art that various modifications, corrections, substitutions, additions, deletions, and equivalents can be conceived within the scope described in the claims, and it is understood that such modifications, corrections, substitutions, additions, deletions, and equivalents also fall within the technical scope of the present disclosure. In addition, components in the embodiment described above may be combined freely in a range without departing from the gist of the invention.

### INDUSTRIAL APPLICABILITY

The technique of the present disclosure is useful for dispatch of a taxi.

### CROSS-REFERENCE TO RELATED APPLICATIONS

This application is based on and claims priority under 35 USC 119 from Japanese Patent Application No. 2024-127841 filed on Aug. 2, 2024, the contents of which are incorporated herein by reference.

What is claimed is:

1. A terminal control method executed by a terminal including a wireless communication device, a display device, and a vibration device, the terminal control method comprising:
transmitting, by the wireless communication device, a call request for a vehicle to an outside;
receiving first information associated with the call request from the outside in the wireless communication device;
displaying, by the display device, a first display corresponding to the first information;
displaying, by the display device, a second display different from the first display when the wireless communication device receives a notification that the first display displayed on the display device is recognized by the vehicle from the outside; and
vibrating the vibration device when the wireless communication device receives a notification that the second display displayed on the display device is recognized by the vehicle from the outside.

2. The terminal control method according to claim 1, wherein
transmitting, by the wireless communication device, the call request for the vehicle to the outside,
receiving the first information associated with the call request from the outside in the wireless communication device,
displaying, by the display device, the first display corresponding to the first information,
vibrating the vibration device and displaying, by the display device, the second display different from the first display when the wireless communication device receives the notification that the first display displayed on the display device is recognized by the vehicle from the outside, and
vibrating the vibration device when the wireless communication device receives the notification that the second display displayed on the display device is recognized by the vehicle from the outside.

3. The terminal control method according to claim 1, wherein
transmitting, by the wireless communication device, the call request for the vehicle to a predetermined server,
receiving the first information associated with the call request from the predetermined server in the wireless communication device,
displaying, by the display device, the first display,
vibrating the vibration device and displaying, by the display device, the second display when the wireless communication device receives the notification that the first display displayed on the display device is recognized by the vehicle from the predetermined server, and
vibrating the vibration device when the wireless communication device receives the notification that the second display displayed on the display device is recognized by the vehicle from the predetermined server.

4. The terminal control method according to claim 1, wherein
the second display has a larger amount of information than the first display.

5. The terminal control method according to claim 1, wherein
the first display and the second display each include a two-dimensional code.

6. The terminal control method according to claim 1, wherein
the first display and the second display each are a first color display of a first color, and the first color display has a predetermined area, or
the first display and the second display each are a second color display obtained by combining a plurality of colors, and the second color display has the predetermined area.

7. The terminal control method according to claim 1, wherein
the first display and the second display each are a third color display of a second color, and the third color display has a predetermined area, or
the first display and the second display each are switched between a fourth color display of a third color and a fifth color display of a fourth color one or more times, and the fourth color display and the fifth color display each have a predetermined area.

8. The terminal control method according to claim 1, wherein
transmitting, by the wireless communication device, the call request for the vehicle to the outside,
receiving the first information associated with the call request from the outside in the wireless communication device,
displaying, by the display device, the first display,
displaying, by the display device, the second display different from the first display when the wireless communication device receives the notification that the first display displayed on the display device is recognized by the vehicle from the outside, and
vibrating the vibration device and displaying, by the display device, a third display different from the first display and different from the second display when the wireless communication device receives the notification that the second display displayed on the display device is recognized by the vehicle from the outside.

9. The terminal control method according to claim 8, wherein
the third display is used for boarding authentication for the vehicle.

10. The terminal control method according to claim 1, wherein
the vibration device includes a vibrator and a speaker.
